(19) United States
(12) Patent Application Publication
(10) Pub. No.: US 2023/0176409 A1
(43) Pub. Date: Jun. 8, 2023

(54) DISPLAY DEVICE AND METHOD FOR MANUFACTURING SAME

(71) Applicant: SAMSUNG ELECTRONICS CO., LTD., Suwon-si (KR)

(72) Inventors: Seojoon LEE, Suwon-si (KR); Myeonggil KIM, Suwon-si (KR); Hyongjun YOO, Suwon-si (KR); Hyunjun JUNG, Suwon-si (KR); Seungsan HAN, Suwon-si (KR)

(73) Assignee: SAMSUNG ELECTRONICS CO., LTD., Suwon-si (KR)

(21) Appl. No.: 18/105,306

(22) Filed: Feb. 3, 2023

Related U.S. Application Data
(63) Continuation of application No. PCT/KR2021/008937, filed on Jul. 13, 2021.

(30) Foreign Application Priority Data
Sep. 10, 2020 (KR) 10-2020-0116271

(51) Int. Cl. G02F 1/1333; G02F 1/1335

(52) U.S. Cl. CPC G02F 1/133322; G02F 1/133314; G02F 1/133317; G02F 1/133302; G02F 1/133528; G02F 1/13332; G02F 2201/083; B23K 26/324

(57) ABSTRACT

A display device including a rear chassis, a display panel arranged in front of the rear chassis to display an image, a middle mold arranged between the display panel and the rear chassis and coupleable to the rear chassis, an optical member arranged between the rear chassis and the display panel, and a welding portion formed by laser-welding the display panel and at least one of the middle mold or the optical member.

### CROSS-REFERENCE TO RELATED APPLICATION

This application is a continuation application, under 35 U.S.C. § 111(a), of international application No. PCT/KR2021/008937, filed on Jul. 13, 2021, which claims priority under 35 U. S. C. § 119 to Korean Patent Application No. 10-2020-0116271, filed Sep. 10, 2020, the disclosures of which are incorporated herein by reference in their entirety.

### BACKGROUND

### Field

The disclosure relates to a display device and method for manufacturing the same, and more particularly, to a display device and method for manufacturing the same capable of reducing a bezel.

### Discussion of Related Art

A display device is a kind of output device for visually presenting data information and images, such as text or figures, including a television, various kinds of monitors, many different kinds of portable terminals (e.g., notebooks, tablet personal computers (PCs), and smart phones), etc.

The display device may include a display panel for presenting a screen and a bezel arranged on edges of the display panel.

Display devices with slim or no bezel are being developed these days to enhance the aesthetic impression.

### SUMMARY

According to an aspect of the disclosure, a display device includes a rear chassis, a display panel arranged in front of the rear chassis, a middle mold arranged between the display panel and the rear chassis while the middle mold is coupled with the rear chassis, an optical member arranged between the rear chassis and the display panel, a welding portion formed by laser-welding the display panel and at least one of the middle mold or the optical member, and an infrared absorbent applied between the display panel and at least one of the middle mold or the optical member.

The display panel may include a glass substrate and a polarizing film, and the middle mold may be coupleable to at least one of the glass substrate or the polarizing film by laser welding.

The polarizing film may be arranged to cover the glass substrate, and the middle mold may be laser-welded to the polarizing film.

The polarizing film may be among a plurality of polarizing films, the plurality of polarizing films may include a first polarizing film facing a back of the display device and a second polarizing film facing a front of the display device, and the middle mold may be laser-welded to the first polarizing film.

The polarizing film may be arranged to cover the glass substrate, and at least a portion of the glass substrate may be exposed to the middle mold from the polarizing film and laser-welded.

The glass substrate may be among a plurality of glass substrates, the plurality of glass substrates may include a first glass substrate facing back and a second glass substrate facing front, and the middle mold may be laser-welded to the first glass substrate.

The display panel may transmit infrared rays and the middle mold may absorb infrared rays, so that the display panel and the middle mold may be laser-welded.

The display panel may include a dead space (DS) which is a non-display area and on which infrared transmitting ink is applied.

The middle mold may transmit infrared rays and the display panel may absorb infrared rays, so that the display panel and the middle mold may be laser-welded.

The display panel may include at least one of a glass substrate with an infrared absorbent applied thereon or a polarizing film absorbing infrared rays.

The display panel may include a glass substrate and a polarizing film, and may further include a front chassis provided to cover the display panel and coupleable to at least one of the glass substrate or the polarizing film by laser welding.

The polarizing film may be arranged to cover the glass substrate, and the front chassis may be laser-welded to the polarizing film.

The polarizing film may be arranged to cover the glass substrate, and at least a portion of the glass substrate may be exposed to the front chassis from the polarizing film and laser-welded.

The display panel may include a glass substrate and a polarizing film, and the optical member may be coupleable to at least one of the glass substrate or the polarizing film by laser welding.

The welding portion may be a plurality of welding portions, and the plurality of welding portions may include a first welding portion formed by laser welding of the polarizing film and the optical member and a second welding portion formed by laser welding of the optical member and the middle mold.

According to an aspect of the disclosure, a display device includes a rear chassis, a display panel arranged in front of the rear chassis, a front chassis provided to cover the display panel and formed of at least one of a plastic or metallic material, and an infrared absorbent applied between the display panel and the front chassis, wherein the front chassis may be coupleable to the display panel by laser welding.

The display panel may include a dead space (DS) which is a non-display area and on which infrared transmitting ink is applied, and the front chassis may be formed of a metallic material and laser-welded to the display panel by absorbing infrared laser.

The display panel may include at least one of a glass substrate with an infrared absorbent applied thereon or a polarizing film absorbing infrared, and the front chassis may be formed of a plastic material and laser-welded to the display panel by transmitting infrared laser.

According to an aspect of the disclosure, a method of manufacturing a display device includes arranging a rear chassis, arranging a display panel in front of the rear chassis, arranging a middle mold between the display panel and the rear chassis, arranging an optical member between the rear chassis and the display panel, applying an infrared absorbent between the display panel and the middle mold or between the display panel and the optical member, and laser-welding the display panel to the middle mold or the optical member.

Applying infrared transmitting ink onto the display panel may be further included.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 illustrates an exterior of a display device, according to an embodiment of the disclosure.

FIG. 2 is an exploded view of a major structure of a display device, according to an embodiment of the disclosure.

FIG. 3 is a cross-sectional perspective view of a display device, according to an embodiment of the disclosure.

FIG. 4 is a cross-sectional view of a display device, according to an embodiment of the disclosure.

FIG. 5 is a cross-sectional view of a display device, according to another embodiment of the disclosure.

FIG. 6 is a cross-sectional view of a display device, according to another embodiment of the disclosure.

FIG. 7 is a cross-sectional view of a display device, according to another embodiment of the disclosure.

FIG. 8 illustrates a method of manufacturing a display device, according to an embodiment of the disclosure.

### DETAILED DESCRIPTION OF EXEMPLARY EMBODIMENTS

Embodiments and features as described and illustrated in the disclosure are merely examples, and there may be various modifications replacing the embodiments and drawings at the time of filing this application.

Throughout the drawings, like reference numerals refer to like parts or components.

The terminology used herein is for the purpose of describing particular embodiments only and is not intended to limit the disclosure. It is to be understood that the singular forms “a,” “an,” and “the” include plural references unless the context clearly dictates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The terms including ordinal numbers like “first” and “second” may be used to explain various components, but the components are not limited by the terms. The terms are only for the purpose of distinguishing a component from another. Thus, a first element, component, region, layer or room discussed below could be termed a second element, component, region, layer or section without departing from the teachings of the disclosure.

Descriptions shall be understood as to include any and all combinations of one or more of the associated listed items when the items are described by using the conjunctive term “˜ and/or ˜,” or the like.

The terms “front”, “rear”, “left” and “right” as herein used are defined with respect to the drawings, but the terms may not restrict the shape and position of the respective components.

The disclosure provides a display device and method for manufacturing the same, by which productivity and degree of freedom of design may increase by directly coupling components without using an extra structure or bonding medium.

The disclosure provides a display device and method for manufacturing the same, by which the size of a bezel is reduced to enhance the aesthetic impression.

The disclosure also provides a display device and method for manufacturing the same, by which the thickness from front to back is reduced to enhance the aesthetic impression.

According to the disclosure, a display device and method for manufacturing the same, by which productivity and degree of freedom of design increases by omitting an extra structure or bonding medium, may be provided.

According to the disclosure, a display device and method for manufacturing the same, by which the size of a bezel is reduced to enhance the aesthetic impression, may be provided.

According to the disclosure, a display device and method for manufacturing the same, by which thickness from front to back is reduced to enhance the aesthetic impression, may be provided.

Reference will now be made in detail to embodiments of the disclosure, which are illustrated in the accompanying drawings.

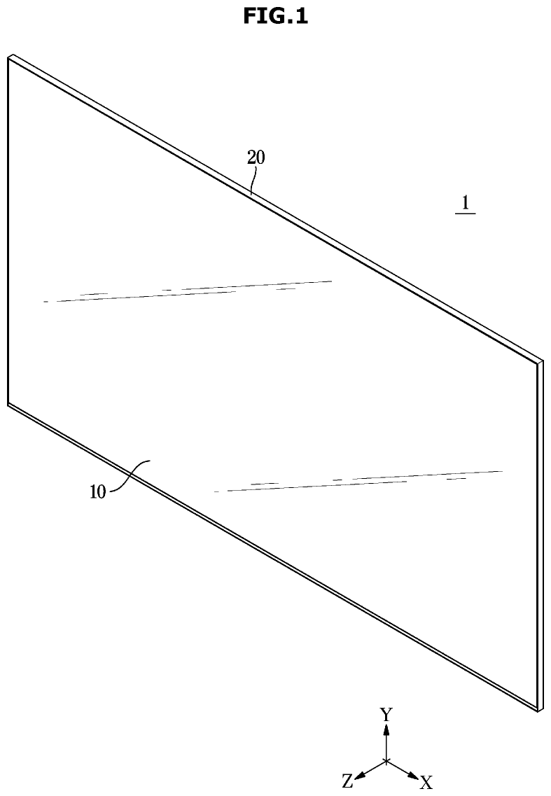

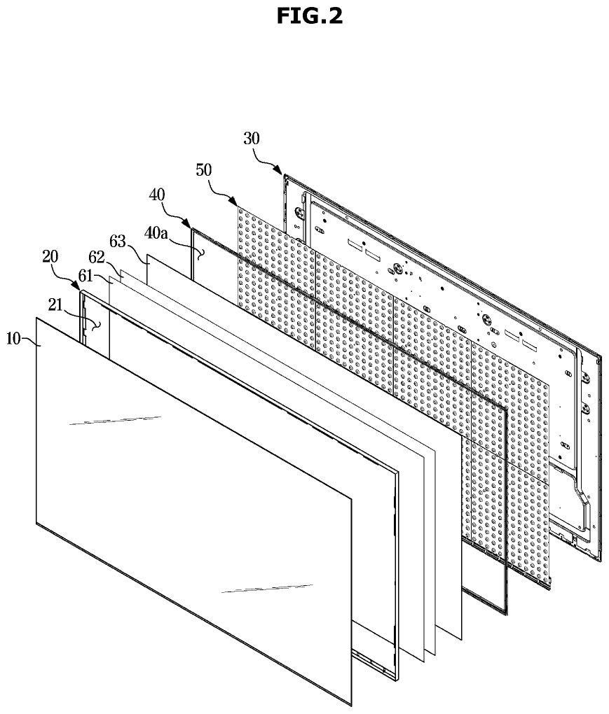

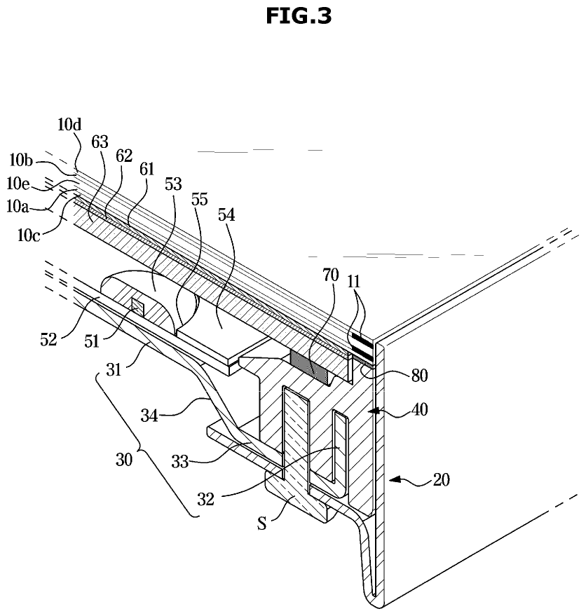

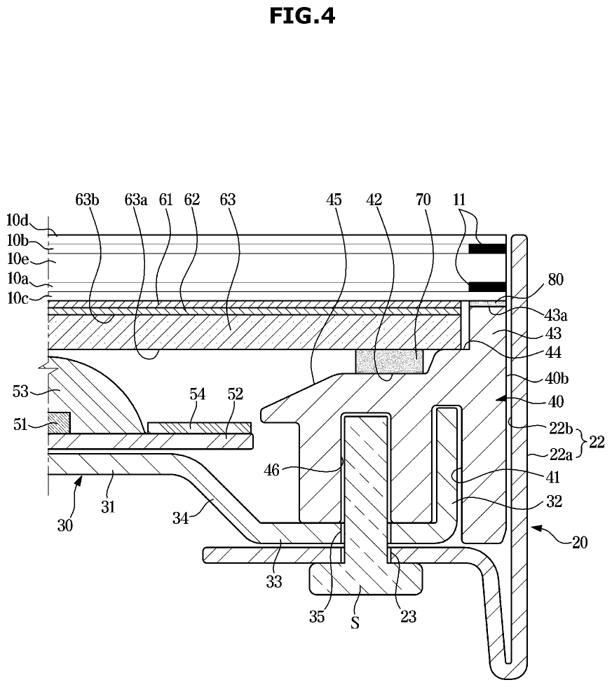

FIG. 1 illustrates an exterior of a display device, according to an embodiment of the disclosure. FIG. 2 is an exploded view of a major structure of a display device, according to an embodiment of the disclosure. FIG. 3 is a cross-sectional view of a display device, according to an embodiment of the disclosure. FIG. 4 is a cross-sectional view of a display device, according to an embodiment of the disclosure.

Referring to FIGS. 1 to 4, a display device according to an embodiment of the disclosure will now be described.

A display device 1 may include a display panel 10 for displaying an image, a backlight unit arranged behind the display panel 10 to provide light to the display panel 10, a rear chassis 30 arranged to support the backlight unit, a front chassis 20 arranged to cover edges of the display panel 10, and a middle mold 40 coupled between the front chassis 20 and the rear chassis 30. The middle mold 40 may be injection molded. A material for injection of the middle mold 40 may include plastic, but it is not limited thereto and may be various materials for injection.

Although the front chassis 20 is shown in the drawings, the front chassis 20 is not an essential element but may be omitted. In this case, the middle mold 40 may support various components such as the display panel 10 and optical members 61, 62 and 63.

The display panel 10 may include a plurality of glass substrates. The plurality of glass substrates may include a first glass substrate 10a formed in the shape of a flat square plate and a second glass substrate 10b formed in the shape of a flat square plate and arranged in front of the first glass substrate 10a. Furthermore, the display panel 10 may include a liquid crystal layer 10e arranged between the first glass substrate 10a and the second glass substrate 10b.

The second glass substrate 10b may be integrally formed with a thin film transistor (TFT) (not shown). The TFT may control a current flowing in the thin film semiconductor However, the second glass substrate 10b and the TFT may be detachably coupled to each other.

A non-display area (NDA) in which no image is displayed may be formed in outer portions of the first glass substrate 10a and the second glass substrate 10b. Various members (not shown) for deriving display areas may be mounted on the NDA. The NDA may be referred to as a dead space (DS) 11. The size of the DS 11 is not limited to what is shown in the drawings.

Furthermore, the display panel 10 may include a plurality of polarizing films. The plurality of polarizing films may include a first polarizing film 10c arranged on a rear surface of the first glass substrate 10a and a second polarizing film 10d arranged on a front surface of the second glass substrate 10b, so that the front surface of the second polarizing film 10d may form the front surface of the display panel 10. In other words, the plurality of polarizing films 10c and 10d may be arranged outer sides of the plurality of glass substrates 10a and 10b. The plurality of polarizing films 10c and 10d may cover the plurality of glass substrates 10a and 10b.

The first polarizing film 10c and the second polarizing film 10d may be formed of a material such as polyethylene terephthalate (PET), acryl, etc. It is not, however, limited thereto, and they may be formed with other various materials. The polarizing films 10c and 10d may absorb infrared laser.

The backlight unit is arranged behind the display panel 10 to illuminate the display panel 10. The backlight unit may include a light source module 50 including a light source 51 and a substrate 52 with the light source 51 mounted thereon, and an optical member arranged in a traveling path of the light emitted from the light source 51.

In an embodiment of the disclosure, the light source module 50 may include a plurality of substrates 52 provided in the form of plates. It is not, however, limited thereto, but the substrates may have the form of bars.

The size and/or number of light source modules 50 may depend on the size of the display device 1. In an embodiment of the disclosure, there may be eight light source modules 50, and the size of the eight light source modules 50 combined may be equal to the size of the display panel 10.

A driving power line may be formed on the substrate 52 to supply driving power to the light source 51 and connected to a signal cable (not shown) and a backlight driving circuit (not shown).

A plurality of light sources 51 may be mounted on each of the plurality of substrates 52 with certain gaps. The light source 51 may include light emitting diodes (LEDs). Alternatively, the light source 51 may include a cold cathode fluorescent lamp (CCFL) or an external electrode fluorescent lamp (EEFL).

In the embodiment of the disclosure, a plurality of lenses 53 may be mounted on the substrate 53 to cover the respective light sources 51. The lens 53 may cover the light source 51 to diffuse light emitted from the light source 51.

A reflector sheet 54 may be provided for each of the plurality of substrates 52. The reflector sheet 54 may have the size corresponding to the substrate 52. The reflector sheet 54 may stick to a mounting surface of the substrate 52 on which the light source 51 is mounted. In other words, the reflector sheet 54 may be placed on the upper surface of the substrate 52. The reflector sheet 54 may have a through hole 55 formed for the light source 51 and the lens 53 to pass through.

The reflector sheet 54 may reflect light to prevent losses of light. Specifically, the reflector sheet 54 may reflect light emitted from the light source 51 or light reflecting backward from a diffuser plate 63 to the rear surface 63a of the diffuser plate 63. The reflector sheet 54 may prevent losses of light emitted from the light source 51 by hindering the light emitted from the light source 51 from traveling to the back of the display device 1.

The backlight unit may include optical members 61, 62, and 63 arranged along the traveling path of light emitted from the light source 51.

The optical members 61, 62, and 63 may include a diffuser plate 63 for uniformly diffusing uneven light emitted from the light source 51, and first and second optical sheets 61 and 62 for enhancing properties of light.

The diffuser plate 63 may uniformly diffuse the uneven light generated from the light sources 51. The diffuser plate 63 may uniformly diffuse the light incident on the rear surface 63a to be output to the front surface 63b.

The first and second optical sheets 61 and 62 may be arranged in front of the diffuser plate 63 to enhance optical properties of the light output from the diffuser plate 63. Although the first and second optical sheets 61 and 62 are shown in the drawings, the number of optical sheets may be more or less than 2.

The first and second optical sheets 61 and 62 may include a diffuser sheet for offsetting a pattern of the diffuser plate 63, a prism sheet for concentrating the light to enhance brightness, a protection sheet for protecting the other optical sheets against an external shock or inflow of foreign materials, a reflective polarizing sheet (e.g., dual brightness enhancement film (DBEF)) for transmitting polarized light while reflecting differently polarized light to enhance brightness, a complex sheet for uniformly diffusing light, a quantum dot sheet for changing wavelengths of light to improve color reproductivity, etc. Quantum dots, which are illuminant semiconductor crystals in a few nanometers, may be distributed inside the quantum dot sheet. The quantum dot may receive blue light to produce any colors of visible light depending on the size of the quantum dot. The smaller the quantum dot is, the shorter wavelength of light may be produced, and the larger the quantum dot is, the longer wavelength of light may be produced.

The first and second optical sheets 61 and 62 and the diffuser plate 63 may be provided in one body. Bonding members may be provided between the first and second optical sheets 61 and 62 and between the second optical sheet 62 and the diffuser plate 63, integrating the first and second optical sheets 61 and 62 and the diffuser plate 63 into one body like a single sheet. In other words, the first and second optical sheets 61 and 62, and the diffuser plate 63 integrally formed may be an all-in-one profits (AIOP) sheet. The optical members 61, 62 and 63 may be the AIOP sheet.

The rear chassis 30 may be arranged behind the backlight unit. In the embodiment of the disclosure, the rear chassis 30 may be shaped substantially like a plate with the edges bending forward. The backlight unit may be received between the rear chassis 30 and the display panel 10 and front chassis 20.

The rear chassis 30 may include a base 31 on which the light source module 50 is installed, and a bent portion 32 formed on the top, bottom, left and right edges of the rear chassis 30 to be coupled with the middle mold 40.

The base 31 may contact the substrate 52 to radiate heat generated from a heating element such as the light source 51 mounted on the substrate 52. For this, the rear chassis 30 including the base 31 may be formed with, but not exclusively to, various metal substances such as aluminum, steel use stainless (SUS), etc., with high heat transfer efficiency. The rear chassis 30 may be formed with a plastic material such as ABS.

The bent portion 32 may be inserted to an insertion groove 41 formed at the middle mold 40. When the bent portion 32 is inserted to the insertion groove 41, the rear chassis 30 and the middle mold 40 may be primarily coupled to each other.

The rear chassis 30 may further include a middle mold supporter 33 for supporting the middle mold 40, and a link 34 connecting the middle mold supporter 33 to the base 31.

The middle mold supporter 33 may be formed between the bent portion 32 and the base 31 to support the middle mold 40. The link 34 may be provided to connect the middle mold supporter 33 and the base 31. The link 34 may slantingly extend backward from an end of the base 31 to connect to an end of the middle mold supporter 33. The bent portion 32 may be formed at the other end of the middle mold supporter 33.

The light source module 50 may be placed between the base 31 and the diffuser plate 63, and the middle mold 40 may be placed between the middle mold supporter 33 and the diffuser plate and the display panel 10. A distance between the base 31 and the display panel 10 may be shorter than a distance between the middle mold supporter 33 and the display panel 10.

The front chassis 20 may be shaped like a frame with an opening 21 for the light from the backlight unit to be provided to the display panel 10. The front chassis 20 may be provided to cover the sides of the display panel 10 and the middle mold 40.

The front chassis 20 may be provided to cover the sides of the display panel 10 but not to cover the front of the display panel 10. As the front chassis 20 does not cover the display area of the display panel 10, the size of the display area of the display panel 10 does not shrink from the front chassis 20. Accordingly, the size of the display area of the display panel 10 of the display device 1 may be enlarged.

Furthermore, thickness of the front chassis 20 in the left-right direction may be reduced. The thickness of the front chassis 20 in the left-right direction may indicate the size of the bezel. The front chassis 20 has a structure to perform a function of covering the sides of the display panel 10 and the middle mold 40, even without having heavy thickness of the front chassis 20. Accordingly, the display device 1 may have a bezel with a reduced size, and thus have an enhanced aesthetic impression.

Similar to the front chassis 20, the middle mold 40 may be shaped like a frame with an opening 40a for the light from the backlight unit to be provided to the display panel 10.

The middle mold 40 may be coupled to the rear chassis 30 and the front chassis 20. The middle mold 40 may fix the diffuser plate 63 and the first and second optical sheets 61 and 62. Furthermore, the middle mold 40 may fix the display panel 10.

The middle mold 40 may be placed on the middle mold supporter 33 of the rear chassis 30. The middle mold 40 may include the insertion groove 41 for the bent portion 32 of the rear chassis 30 to be inserted thereto. As described above, as the bent portion 32 is inserted to the insertion groove 41, the middle mold 40 and the rear chassis 30 may be primarily coupled to each other.

The middle mold 40 may fix the diffuser plate 63. The middle mold 40 may include a sheet bonding surface 42. The sheet bonding surface 42 is a surface of the middle mold 40 facing the diffuser plate 63 at a certain distance from the diffuser plate 63.

A bonding member 70 may be provided between the sheet bonding surface 42 and the diffuser plate 63. The bonding member 70 may be made with a transparent substance. For example, the bonding member 70 may include a pressure sensitive adhesive (PSA) having more than 90% of light transmittance. With the bonding member 70 made with a material having high light transmittance, light emitted from the light source module 50 may pass through the bonding member 70 and enter into the diffuser plate 63. This may prevent losses of light. The bonding member 70 is not, however, limited to the adhesive, but may be formed by various bonding methods such as laser welding.

The bonding member 70 may be provided to bond the sheet bonding surface 42 of the middle mold 40 and the rear surface 63a of the diffuser plate 63. With the bonding member 70, the optical members 61, 62, and 63 may be coupled to the middle mold 40 without an extra structure.

The optical members 61, 62, and 63 may be coupled to the middle mold 40 by the bonding member 70 without an extra structure. Accordingly, the display device may become slim and the bezel size may also be reduced.

The middle mold 40 may be coupled to the display panel 10 to prevent the display panel 10 from falling out forward from the display device 1. The middle mold 40 may include the supporting projection 43 protruding toward the display panel 10. The supporting projection 43 may include a panel bonding surface 43a facing the rear surface of the display panel 10. A welding portion 80 may be provided between the panel bonding surface 43a and the rear surface of the display panel 10. The welding portion 80 may be provided to bond the panel bonding surface 43a of the middle mold 40 and the rear surface of the display panel 10. With the welding portion 80, the display panel 10 may be fixedly coupled to the middle mold 40.

The display panel 10 may be laser-welded to the middle mold 40. The display panel 10 may be laser-welded to the middle mold 40 along edge lines of the display panel 10. The display panel 10 may be laser-welded to the supporting projection 43 of the middle mold 40. That is, the display panel 10 may be laser-welded on the panel bonding surface 43a to form the welding portion 80.

The laser may be infrared laser having a wavelength in a range of 800 nm to 1100 nm. It is not, however, limited thereto, and infrared laser of various wavelength ranges may be used.

Specifically, the middle mold 40 may be laser-welded to the first polarizing film 10c of the display panel 10. The middle mold 40 and the first polarizing film 10c may be laser-welded to form the welding portion 80. The welding portion 80 may be formed by irradiating the laser from the side of the display panel 10 to the side of the middle mold 40. In this case, the laser may be transmitted through the first polarizing film 10c, and the middle mold 40 may absorb the laser energy. Accordingly, the first polarizing film 10c and the middle mold 40 may be deposited. Furthermore, as shown in the drawings, the welding portion 80 may be arranged between the DS 11 and the middle mold 40.

The display panel 10 (i.e., the first polarizing film 10c) is directly coupled with the middle mold 40 without the use of a structure or a bonding medium that is otherwise used, thereby improving productivity and saving production costs. In addition, the design quality may be improved because the extra structure is omitted.

However, the welding portion 80 is formed not only by laser welding but also by various welding methods such as ultrasonic welding.

Infrared transmitting ink may be applied onto the DS 11 for the first polarizing film 10c to transmit the infrared laser. The infrared transmitting ink may include organic pigment-based dispersion.

Unlike what is described above, it may be formed by irradiating the laser from the side of the middle mold 40 to the side of the display panel 10. In this case, the laser may be transmitted through the middle mold 40 and the first polarizing film 10c may absorb the laser energy. Accordingly, the first polarizing film 10c and the middle mold 40 may be deposited.

Ink unable to transmit infrared rays may be applied onto the first polarizing film 10c to absorb energy of the infrared laser more easily. The ink unable to transmit infrared rays may include a carbon black system.

Furthermore, an infrared absorbent may be applied onto the middle mold 40 to increase bonding power through welding. The infrared absorbent may be able to selectively absorb a certain wavelength. It is not, however, limited thereto, but the infrared absorbent may be applied between the middle mold 40 and the first polarizing film 10c.

A direction in which the laser is irradiated is not limited to the above examples, and it is also possible that the laser is irradiated from a side of at least one of the middle mold 40 or the first polarizing film 10c for welding.

Hence, as the area that transmits infrared rays and the area that absorbs infrared rays are not limited to particular components, productivity may be improved and various manufacturing methods may be applied depending on the process condition. Accordingly, production convenience and production degree of freedom of the display device may be improved.

The middle mold 40 may further include a sheet supporting plane 44 arranged between the supporting projection 43 and the sheet bonding surface 42. The sheet supporting plane 44 may protrude almost as much as the thickness of the bonding member 70 from the sheet bonding surface 42 toward the diffuser plate 63. The sheet supporting plane 44 may be provided to contact and support the diffuser plate 63. The supporting projection 43 may protrude toward the display panel 10 from the sheet supporting plane 44. Alternatively, the sheet supporting plane 44 may not contact the diffuser 63 or may be omitted. When the sheet supporting plane 44 is omitted, the supporting projection 43 may be formed by protruding from the sheet bonding surface 42.

In the embodiment of the disclosure, the middle mold 40 may include a light guide plane 45. The light guide plane 45 may guide light generated from the light source 51 to enter into the diffuser plate 63. Specifically, the light guide plane 45 may guide the light generated from the light source 51 to enter into the bonding member 70 or to a side of the diffuser plate 63 that comes into contact with the bonding member 70.

The light guide plane 45 provides a traveling path for light to allow the light to reach a location where the bonding member 70 is placed. Accordingly, the display device 1 may prevent deterioration or unevenness of brightness of the display panel 10.

The middle mold 40 may be arranged not to protrude sideways from the display panel 10. In other words, an outermost side 40b of the middle mold 40 may be coplanar with a side of the display panel 10, or located farther inside than the side of the display panel 10. Although the side 40b of the middle mold 40 is shown as being coplanar with the side of the display panel 10, it may be located farther inside than the side 10 of the display panel 40.

A side 22 of the front chassis 20 may be arranged to cover sides of the display panel 40 and the middle mold 10. The side 22 of the front chassis may include an inner side surface 22a facing the side 40b of the middle mold and an outer side surface 22b opposite to the inner side surface 22a. According to the disclosure, the inner side surface 22a and the outer side surface 22b may be provided side by side and may extend in an almost straight line along the front-back direction. A distance between the inner and outer side surfaces 22a and 22b of the front chassis 20 corresponds to the size of the bezel of the display device. According to the disclosure, the inner and outer side surfaces 22a and 22b of the front chassis 20 do not protrude sideways but extend in an almost straight line along the front-back direction, so the size of the bezel may be very thin.

According to the disclosure, the middle mold 40 may be provided without such a portion that protrudes outwards from the display panel 10. The front chassis 20 may be arranged very closely to the sides of the display panel 10 because there is no portion protruding outwards from the display panel 10. Furthermore, the front chassis 20 is a component provided to cover the sides of the display panel 10 and the sides of the middle mold 40, so it may perform the function of covering the sides even when the thickness become small. Accordingly, the thickness of the side 22 of the front chassis 20 may be provided to be very thin. As the size of the bezel is proportional to the thickness of the side 22 of the front chassis 20, the size of the bezel of the display device 1 may be reduced by minimizing the thickness of the side 22 of the front chassis. With the reduced size of the bezel, the display device 1 may give an enhanced aesthetic impression.

In the embodiment of the disclosure, the front chassis 20, the rear chassis 30, and the middle mold 40 may be combined by a fastening member S that is provided separately. The middle mold 40 may include a fastening groove 46 into which the fastening member S is inserted and coupled. The rear chassis 30 may include a first fastening hole 35 formed to match the fastening groove 46 and for the fastening member S to pass through. The front chassis 20 may include a second fastening hole 23 formed to match the fastening groove 46 and the first fastening hole 35 and for the fastening member S to pass through.

The fastening member S may pass through the first and second fastening holes 35 and 23 to be fastened into the fastening groove 46. In an embodiment of the disclosure, the fastening member S may be screwed into the fastening groove 46. When the fastening member S is fastened into the fastening groove 46, the front chassis 20 may be fixedly coupled to the rear chassis 30. Furthermore, when the fastening member S is fastened into the fastening groove 46, the rear chassis 30 and the middle mold 40 may be secondarily coupled to each other.

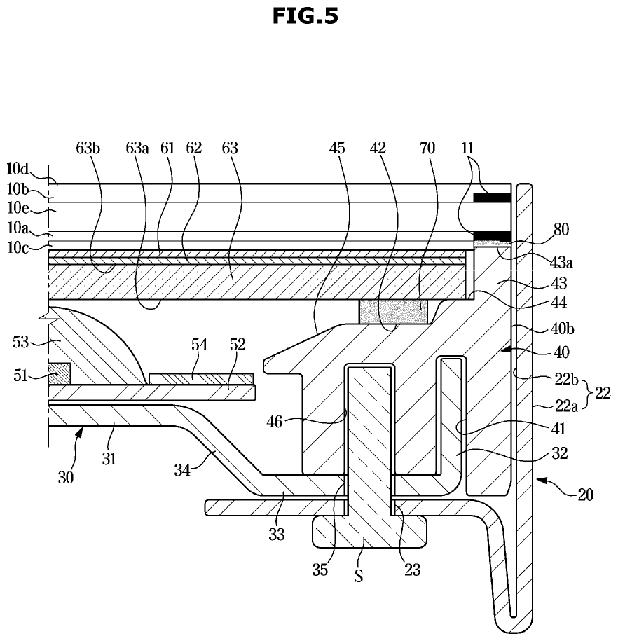

FIG. 5 is a cross-sectional view of a display device, according to another embodiment of the disclosure.

The same features as in the aforementioned embodiment are denoted by the same reference numerals, and the overlapping description will not be repeated.

Referring to FIG. 5, the first polarizing film 10c may form to be shorter than the first glass substrate 10a. In other words, the first glass substrate 10a may be exposed from the first polarizing film 10c. Accordingly, the glass substrate may be welded to the middle mold 40. Specifically, the first glass substrate 10a may be laser-welded to the middle mold 40 to form the welding portion 80. The welding portion 80 may come into contact with both the first glass substrate 10a and the first polarizing film 10c. The welding portion 80 may come into contact with at least one of the first glass substrate 10a or the first polarizing film 10c.

The display panel 10 may be laser-welded to the middle mold 40. The display panel 10 may be laser-welded to the middle mold 40 along edge lines of the display panel 10. The display panel 10 may be laser-welded to the supporting projection 43 of the middle mold 40. That is, the display panel 10 may be laser-welded on the panel bonding surface 43a to form the welding portion 80.

Specifically, the middle mold 40 may be laser-welded to the first glass substrate 10c of the display panel 10. The middle mold 40 and the first glass substrate 10c may be laser-welded to form the welding portion 80. The welding portion 80 may be formed by irradiating the laser from the side of the display panel 10 to the side of the middle mold 40. In this case, the first glass substrate 10c may transmit the laser, and the middle mold 40 may absorb the laser energy. Accordingly, the first glass substrate 10c and the middle mold 40 may be deposited.

According to the embodiment of the disclosure, the display panel 10 (i.e., the first glass plate 10c) is directly coupled with the middle mold 40 without the use of a structure or a bonding medium that is otherwise used, thereby improving productivity and saving production costs. In addition, the design quality may be improved because the extra structure is omitted.

Infrared transmitting ink may be applied onto the DS 11 for the first glass substrate 10c to transmit the infrared laser. The infrared transmitting ink may include organic pigment-based dispersion.

Unlike what is described above, it may be formed by irradiating the laser from the side of the middle mold 40 to the side of the display panel 10. In this case, the middle mold 40 may transmit the laser and the first glass plate 10c may absorb the laser energy. Accordingly, the first glass substrate 10c and the middle mold 40 may be deposited.

Ink unable to transmit infrared rays may be applied onto the first glass substrate 10c to absorb energy of the laser. Furthermore, an infrared absorbent may be applied onto the middle mold 40.

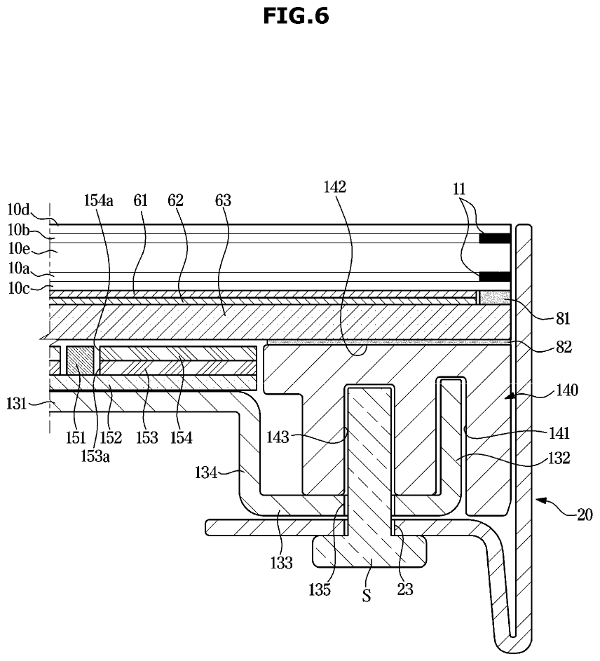

FIG. 6 is a cross-sectional view of a display device, according to another embodiment of the disclosure.

The same features as in the aforementioned embodiment are denoted by the same reference numerals, and the overlapping description will not be repeated.

In the embodiment of the disclosure, the display device may include the display panel 10, a backlight unit arranged behind the display panel 10 to provide light to the display panel 10, a rear chassis 130 for supporting the backlight unit, the front chassis 20 for covering edges of the display panel 10, and a middle mold 140 coupled between the front chassis 20 and the rear chassis 130.

A light source module 150 may include a plurality of substrates 152 provided in the form of plates. It is not, however, limited thereto, but the substrates may have the form of bars.

The size and/or number of light source modules 150 may be different depending on the size of the display device. In the embodiment of the disclosure, there may be eight light source modules 150, and the size of the eight light source modules 150 combined may be equal to the size of the display panel 10.

A plurality of light sources 151 may be mounted on each of the plurality of substrates 152 with certain gaps. The light source 151 may include light emitting diodes (LEDs). A reflector sheet 153 may be placed on the substrate 152. The reflector sheet 153 may reflect light to prevent losses of light. The reflector sheet 153 may include a plurality of through holes 153a for the plurality of light sources 151 to pass through. A light guide film 154 may be placed on the reflector sheet 153. The light guide film 154 may diffuse and guide light generated from the light source 151 to the front. The light guide film 154 may make the light sources 151 from point light sources to a surface light source. Similar to the reflector sheet 153, the light guide film 154 may also include a plurality of through holes 154a.

A link 134 of the rear chassis may be provided to be almost perpendicular to a base 131 and a middle mold supporter 133. A bent portion 132 may be inserted to an insertion groove 141 of the middle mold 140. Accordingly, the middle mold 140 and the rear chassis 130 may be stably coupled to each other.

The middle mold 140 may include a sheet bonding surface 142. No projection may be formed on the sheet bonding surface 142. A second welding portion 82 may be provided between the sheet bonding surface 142 and the rear surface 63a of the diffuser plate 63. The second welding portion 82 may couple the middle mold 140 to the diffuser plate 63 by bonding the sheet bonding surface 142 and the rear surface 63a of the diffuser plate 63.

The display device may include the plurality of welding portions 80. The plurality of welding portions may include a first welding portion 81 and a second welding portion 82.

The display panel 10 may be laser-welded to be fixed onto the diffuser plate 63. The first welding portion 81 may be arranged between the display panel 10 and the diffuser plate 63. In other words, the first welding portion 81 may bond the display panel 10 and the diffuser plate 63. Specifically, the first polarizing film 10c and the diffuser plate 63 may be laser-welded, and the first welding portion 81 may be arranged between the first polarizing film 10c and the diffuser plate 63.

It is not, however, limited thereto, and the display panel 10 and the first optical sheet 61 may be coupled by laser-welding. In this case, the first welding portion 81 may be arranged between the display panel 10 and the first optical sheet. Furthermore, an AIOP sheet in which the first optical sheet 61, the second optical sheet 62, and the diffuser plate 63 are integrally formed and the display panel 10 may be laser-welded to form the first welding portion 81.

Accordingly, without an extra structure, the display panel 10 and the diffuser plate 63 may be coupled, the display panel 10 and the first optical sheet 61 may be coupled, or the display panel 10 and the AIOP sheet may be coupled by the first welding portion 81.

The middle mold 140 may be laser-welded to be fixed onto the diffuser plate 63. The second welding portion 82 may be arranged between the middle mold 140 and the diffuser plate 63. In other words, the second welding portion 82 may bond the middle mold 140 and the diffuser plate 63.

It is not, however, limited thereto, and the MOP sheet in which the first optical sheet 61, the second optical sheet 62, and the diffuser plate 63 are integrally formed and the middle mold 140 may be laser-welded to form the second welding portion 82.

Accordingly, without an extra structure, the middle mold 140 and the diffuser plate 63 may be coupled or the middle mold 140 and the MOP sheet may be coupled by the second welding portion 82.

According to the embodiment of the disclosure, the display panel 10 and the optical member are directly coupled without the use of a structure or a bonding medium that is otherwise used, thereby improving productivity and saving production costs. In addition, the design quality may be improved because the extra structure is omitted.

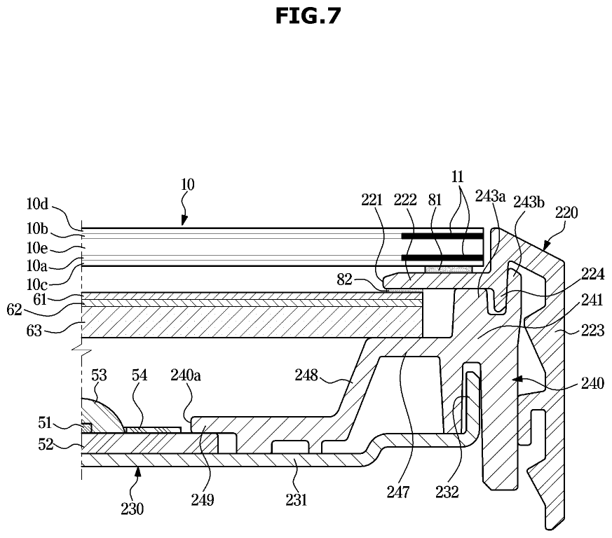

FIG. 7 is a cross-sectional view of a display device, according to another embodiment of the disclosure.

The same features as in the aforementioned embodiment are denoted by the same reference numerals, and the overlapping description will not be repeated.

Referring to FIG. 7, the front chassis 220 may be shaped like a frame with an opening 221 for the light from the backlight unit to be provided to the display panel 10. The front chassis 220 may include a front-side 223 formed on the top, bottom, left and right edges of the front chassis 220 to be coupled with the middle mold 240, and a panel supporter 222 protruding inward from the front-side 223 to support the display panel 10.

The middle mold 240 may be shaped like a frame with an opening 240a. The middle mold 240 may include a frame 241 to which the front chassis 220 and the rear chassis 230 are coupled, an optical member supporter 247 protruding inward from the frame 241 to support the optical members 61, 62 and 63, a reflector 248 extending from the optical member supporter 247 to reflect light, and a substrate supporter 249 extending from the reflector 248 to support the substrate 52.

The frame 241 may be formed on top, bottom, left, and right edges of the middle mold 240. The frame 241 may be coupled with the front chassis 220 and the rear chassis 230 in various known fitting and coupling structures and with extra fastening members.

The middle mold 240 may include a plurality of supporting projections 243a and 234b. The plurality of supporting projections 243a and 243b may include a first supporting projection 243a and a second supporting projection 243b. A projection 224 of the front chassis may be coupled between the first supporting projection 243a and the second supporting projection 243b.

The optical member supporter 247 may protrude inward from the frame 241 to support the optical members 61, 62 and 63. The optical member supporter 247 may support edges of the incident surface of the optical members 61, 62 and 63. The optical member supporter 247 may be formed to be parallel to the base 231 of the rear chassis 230.

The reflector 248 may reflect light emitted from the backlight unit to the incident surface of the diffuser plate 60. The reflector 248 may extend from the optical member supporter 247 inward and backward at an angle.

The substrate supporter 249 may fix the substrate 52 not to be parted from the base 231 of the rear chassis 230. The substrate supporter 249 may be formed at an inner end of the reflector 248.

The frame 241, optical member supporter 247, reflector 248, and substrate supporter 249 of the middle mold 240 may be integrally formed. A highly reflective material may be coated on the surface of the middle mold 240. The highly reflective material may be coated on the entire surface of the middle mold 240, or may be coated only on the surface of the reflector 248.

The display device may include a plurality of welding portions 80. The plurality of welding portion 80 may include the first welding portion 81 and the second welding portion 82.

The display panel 10 and the front chassis 220 may be coupled by laser welding. Specifically, the first polarizing film 10c and the panel supporter 222 of the front chassis may be coupled by laser welding. Accordingly, the first welding portion 81 may be arranged between the first polarizing film 10c and the panel supporter 222.

The first welding portion 81 may be formed by irradiating the laser from the side of the display panel 10 to the side of the front chassis 220. In this case, the laser may be transmitted through the first polarizing film 10c, and the front chassis 220 may absorb the laser energy. Accordingly, the first polarizing film 10c and the front chassis 220 may be deposited. However, the first welding portion 81 is formed not only by laser welding but also by various welding methods such as ultrasonic welding.

According to another embodiment of the disclosure, the display panel 10 (i.e., the first polarizing film 10c) is directly coupled with the front chassis 220 without the use of a structure or a bonding medium that is otherwise used, thereby improving productivity and saving production costs. In addition, the design quality may be improved because the extra structure is omitted.

Unlike what is described above, it may be formed by irradiating the laser from the side of the front chassis 220 to the side of the display panel 10. In this case, the laser may be transmitted through the front chassis 220 and the first polarizing film 10c may absorb the laser energy. Accordingly, the first polarizing film 10c and the front chassis 220 may be deposited. In this case, the front chassis 220 may be formed by metal or plastic injection, and an infrared absorbent may be applied onto the front chassis 220 to increase bonding power through welding. The infrared absorbent may be able to selectively absorb a certain wavelength. It is not, however, limited thereto, but the infrared absorbent may be applied between the front chassis 220 and the first polarizing film 10c.

When the front chassis 220 is formed of a metal material, the front chassis 220 may absorb infrared laser. In this case, infrared transmitting ink may be applied onto the DS 11 of the display panel 10.

When the front chassis 220 is formed of a plastic material, the front chassis 220 is able to both absorb or transmit the infrared laser. In this case, when the front chassis 220 absorbs the laser, infrared transmitting ink may be applied onto the DS 11 of the display panel 10. On the other hand, when the front chassis 220 transmits laser, the glass substrates 10a and 10b or the polarizing films 10c and 10d on which the infrared absorbent is applied may absorb the infrared laser to be welded.

The size of the DS 11 is not limited to what is shown in the drawings.

A direction in which the laser is irradiated is not limited to the above examples, and it is also possible that the laser is irradiated from a side of at least one of the front chassis 220 or the first polarizing film 10c for welding

Furthermore, unlike what is shown in the drawings, the front chassis 220 may be laser-welded to the first glass substrate 10c of the display panel 10. The front chassis 220 and the first glass substrate 10c may be laser-welded to form the first welding portion 81.

According to the embodiment of the disclosure, the display panel 10 (i.e., at least one of the first polarizing film 10c or the first glass substrate l0a) is directly coupled with the front chassis 220 without the use of a structure or a bonding medium that is otherwise used, thereby improving productivity and saving production costs. In addition, the design quality may be improved because the extra structure is omitted.

The front chassis 220 and the optical sheet may be coupled by laser welding. Specifically, the front chassis 220 and the first optical sheet 61 may be coupled by laser welding. Accordingly, the second welding portion 82 may be arranged between the first optical sheet 61 and the front chassis 220. It is not, however, limited thereto, and an AIOP sheet in which the first optical sheet 61, the second optical sheet 62, and the diffuser plate 63 are integrally formed and the front chassis 220 may be coupled by laser welding. Furthermore, the coupling method is not limited to the laser welding but may include various welding methods such as ultrasonic welding.

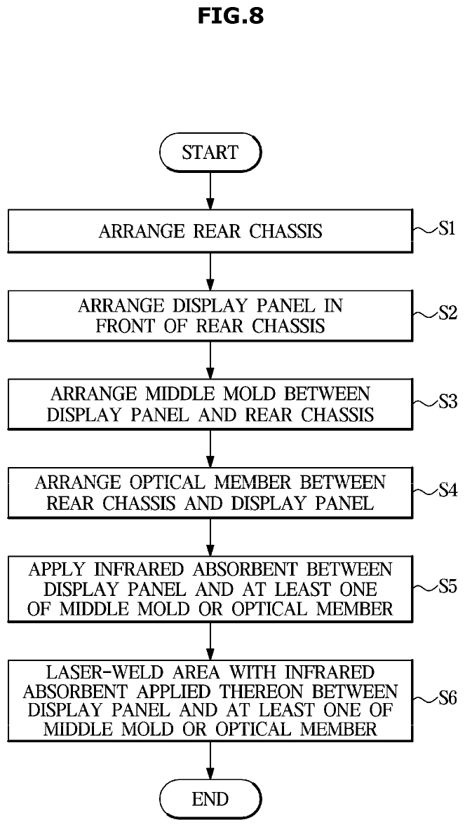

FIG. 8 illustrates a method of manufacturing a display device, according to an embodiment of the disclosure.

Referring to FIG. 8, a method of manufacturing a display device may include arranging the rear chassis 30, 130 or 230 in S1, arranging the display panel 10 in front of the rear chassis 30, 130 or 230 in S2, arranging the middle mold 40, 140 or 240 between the display panel 10 and the rear chassis 30, 130 or 230 in S3, arranging the optical member 61, 62 or 63 between the rear chassis 30, 130 or 230 and the display panel 10 in S4, applying an infrared absorbent between the display panel 10 and at least one of the middle mold 40, 140 or 240 or the optical member 61, 62 or 63 in S5, and laser-welding the display panel 10 to the middle mold 40, 140 or 240 or the optical member 61, 62 or 63 by laser-welding an area on which the infrared absorbent is applied, in S6.

The infrared absorbent may be applied onto at least one of the glass substrate 10a or 10b or the polarizing film 10c or 10d. For example, the infrared absorbent may be applied onto the glass substrate 10a or 10b, and the polarizing film 10c or 10d may absorb infrared laser without application of the infrared absorbent.

It is not, however, limited thereto, and the infrared absorbent may be applied between the front chassis 20 or 220 and the display panel 10, and the display panel 10 and the front chassis 20 or 220 may be laser-welded. It is not limited to the laser welding, but the display panel 10 may be welded to other component through various welding methods such as ultrasonic welding.

A procedure of applying the infrared absorbent may be omitted. Furthermore, the order of arranging the rear chassis 30, 130 or 230, the display panel 10, the middle mold 40, 140 or 240, or the optical member 61, 62 or 63 is not limited to but may be different from what is shown in the drawings. For example, the display panel 10 may be arranged after the rear chassis 30, 130 or 230 and the middle mold 40, 140 or 240 are arranged.

In the method of manufacturing a display device according to the embodiment of the disclosure, the display panel 10 and at least one of the middle mold 40, 140 or 240, the front chassis 20 or 220, or the optical member 61, 62 or 63a are coupled directly without the use of a structure or a bonding medium that is otherwise used, thereby improving productivity and saving the production costs. In addition, the design quality may be improved because the extra structure is omitted.

Several embodiments of the disclosure have been described above, but a person of ordinary skill in the art will understand and appreciate that various modifications can be made without departing from the scope of the disclosure. Thus, it will be apparent to those or ordinary skill in the art that the true scope of technical protection is only defined by the following claims.

What is claimed is:

1. A display device comprising:
a rear chassis;
a display panel in front of the rear chassis;
a middle mold coupleable to the rear chassis so that the middle mold is between the display panel and the rear chassis while the middle mold is coupled to the rear chassis;
an optical member between the rear chassis and the display panel;
a welding portion formed by laser-welding the display panel and at least one of the middle mold or the optical member; and
an infrared absorbent applied between the display panel and at least one of the middle mold or the optical member.

2. The display device of claim 1, wherein the display panel comprises a glass substrate and a polarizing film, and
wherein the middle mold is coupleable to at least one of the glass substrate or the polarizing film by laser welding.

3. The display device of claim 2, wherein the polarizing film is disposed to cover the glass substrate, and
wherein the middle mold is laser-welded to the polarizing film.

4. The display device of claim 3, wherein the polarizing film is among a plurality of polarizing films,
wherein the plurality of polarizing films comprise a first polarizing film facing a back of the display device and a second polarizing film facing a front of the display device, and
wherein the middle mold is laser-welded to the first polarizing film.

5. The display device of claim 2, wherein the polarizing film is disposed to cover the glass substrate, and
wherein while the polarizing film covers the glass substrate, at least a portion of the glass substrate is exposed to the middle mold from the polarizing film and laser-welded.

6. The display device of claim 5, wherein the glass substrate is among a plurality of glass substrates,
wherein the plurality of glass substrates comprise a first glass substrate facing a back of the display device and a second glass substrate facing a front of the display device, and
wherein the middle mold is laser-welded to the first glass substrate.

7. The display device of claim 1, wherein the display panel transmits infrared rays and the middle mold absorbs infrared rays, so that the display panel and the middle mold are laser-welded.

8. The display device of claim 7, wherein the display panel comprises a dead space (DS) which is a non-display area and on which infrared transmitting ink is applied.

9. The display device of claim 1, wherein the middle mold transmits infrared rays and the display panel absorbs infrared rays, so that the display panel and the middle mold are laser-welded.

10. The display device of claim 9, wherein the display panel comprises at least one of a glass substrate on which an infrared absorbent is applied or a polarizing film absorbing infrared rays.

11. The display device of claim 1, wherein the display panel comprises a glass substrate and a polarizing film, and
the display device further comprises a front chassis provided to cover the display panel and coupleable to at least one of the glass substrate or the polarizing film by laser welding.

12. The display device of claim 11, wherein the polarizing film is formed to cover the glass substrate, and
wherein the front chassis is laser-welded to the polarizing film.

13. The display device of claim 12, wherein the polarizing film is formed to cover the glass substrate, and
wherein while the polarizing film covers the glass substrate, at least a portion of the glass substrate is exposed to the front chassis from the polarizing film and laser-welded.

14. The display device of claim 1, wherein the display panel comprises a glass substrate and a polarizing film, and
wherein the optical member is coupleable to at least one of the glass substrate or the polarizing film by laser welding.

15. The display device of claim 14, wherein the welding portion is a plurality of welding portions, and
wherein the plurality of welding portions comprise:
a first welding portion formed by laser-welding the polarizing film and the optical member; and
a second welding portion formed by laser-welding the optical member and the middle mold.
